(19) United States
(12) Patent Application Publication
(10) Pub. No.: US 2006/0069482 A1
(43) Pub. Date: Mar. 30, 2006

(54) Deployment immunity method for a supplemental restraint

(76) Inventor: Junqiang Shen, Kokomo, IN (US)

Correspondence Address: STEFAN V. CHMIELEWSKI;DELPHI TECHNOLOGIES, INC., Legal Staff, Mail Code: 480-410-202, P.O. Box 5052, Troy, MI, 48007-5052, US

(21) Appl. No.: 10/953,997

(22) Filed: Sep. 29, 2004

(51) Int. Cl. B60R 21/32

(52) U.S. Cl. 701/45; 280/735; 180/271

(57) ABSTRACT

Deployment immunity for a supplemental restraint is provided by allowing deployment only when a detected crash is sufficiently severe and immunity conditions involving both velocity and the absolute value of filtered acceleration are satisfied. Utilizing the absolute value of filtered acceleration as an immunity condition minimizes deployment delays while verifying the existence of a crash event, and the velocity condition verifies the direction of the crash energy. This preserves immunity from deployment due to non-deployment events without unnecessarily affecting the timeliness of deployment in a severe crash event.

### TECHNICAL FIELD

The present invention relates to vehicle supplemental restraint systems, and more particularly to a deployment immunity method for distinguishing between deployment events and non-deployment events.

### BACKGROUND OF THE INVENTION

Vehicle supplemental restraint systems perform a number of functions including acceleration sensing, signal processing and analysis, and deployment of one or more restraint devices such as frontal or side air bags and seat belt pretensioners in response to a sensed crash event of sufficient severity. Typically, the acceleration signal is monitored to detect the onset of a crash event (as indicated by acceleration in excess of a reference value, for example), and then filtered or integrated over the course of the crash event to determine the change in velocity (ΔV) due to the crash. The velocity parameter is indicative of the crash severity, and may be compared to a calibrated threshold to determine if the crash event is sufficiently severe to warrant deployment of restraints. Other indications of crash severity such as jerk and oscillation may be used instead of or in addition to the velocity parameter.

Various steps are additionally taken to provide immunity from deployment due to non-deployment crash events, rough road disturbances and so-called abuse events that do not pose a crash hazard to the vehicle occupants. A common immunity approach, described in the U.S. Pat. No. 5,483,449 to Caruso et al., is to compare a filtered version of the acceleration signal to a calibrated threshold while the severity of a crash is being assessed, and to allow deployment of the restraints only when the crash is deemed to be sufficiently severe and the filtered acceleration is above the calibrated threshold. While this technique can effectively rule out deployment of restraints due to various non-deployment events, it can also have the undesired effect of delaying deployment of the restraints in a deployment event due to the oscillatory and bi-polar nature of the acceleration signal. The delay can be as much as 5 milliseconds, which is particularly problematic in the case of side impacts where the deployment must occur very early in the crash event. Accordingly, what is needed is a method of providing immunity from deployment due to non-deployment events without unnecessarily degrading the timeliness of deployment in a severe crash event.

### SUMMARY OF THE PRESENT INVENTION

The present invention is directed to an improved deployment immunity method for a supplemental restraint where the restraints are only deployed when the crash is sufficiently severe and immunity conditions involving both velocity and the absolute value of filtered acceleration are satisfied. Utilizing the absolute value of filtered acceleration as an immunity condition minimizes deployment delays while verifying the existence of a crash event, and the velocity condition verifies the direction of the crash energy. This preserves immunity from deployment due to non-deployment events without unnecessarily affecting the timeliness of deployment in a severe crash event.

### BRIEF DESCRIPTION OF THE DRAWINGS

FIG. 1 is a schematic diagram of a supplemental restraint system including a sensing and diagnostic module (SDM) for carrying out the deployment method of this invention.

FIG. 2 is a block diagram depicting the method of this invention.

### DESCRIPTION OF THE PREFERRED EMBODIMENT

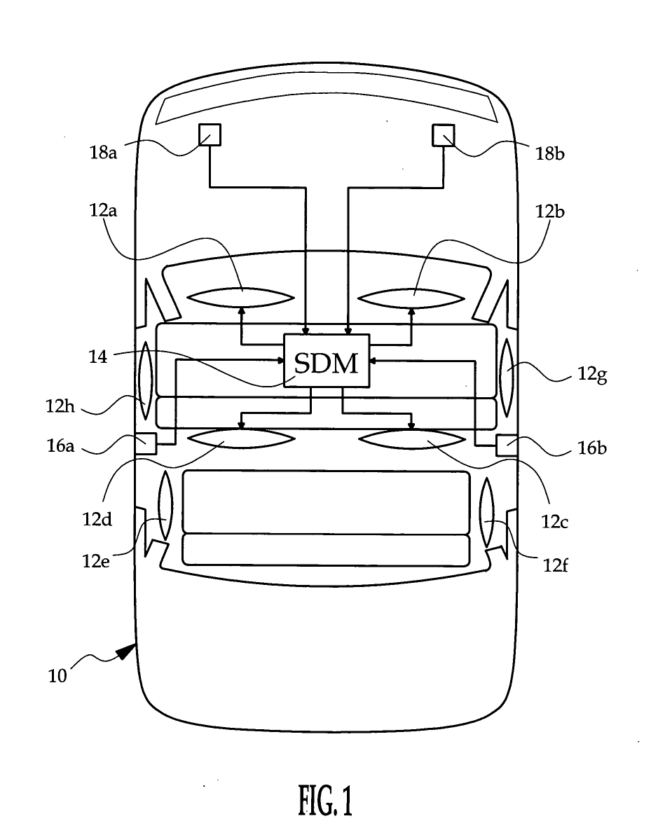

FIG. 1 generally depicts a supplemental restraint system installed in a vehicle 10. The restraint system includes a number of restraints 12a, 12b, 12c, 12d, 12e, 12f, 12g, 12h such as air bags that are variously deployed in a severe crash event to protect the vehicle occupants. The restraints may include without limitation, air bags, belt pretensioners, inflatable tubular structures, side curtains, anti-whiplash devices, etc., and it will be understood that the term airbag as used herein does not refer exclusively to a particular type of restraint. A sensing and diagnostic module (SDM), designated generally by the reference numeral 14, is mounted on a frame element in a central portion of the vehicle 10. In the illustrated embodiment, the restraint system includes a longitudinal acceleration sensor within the SDM 14, a pair of side impact acceleration sensors 16a, 16b and a pair of electronic frontal acceleration sensors 18a, 18b. The SDM 14 additionally includes a programmed microprocessor for receiving the output signals of the acceleration sensors and circuitry for deploying some or all of the restraints 12a-12h in the event of a severe crash.

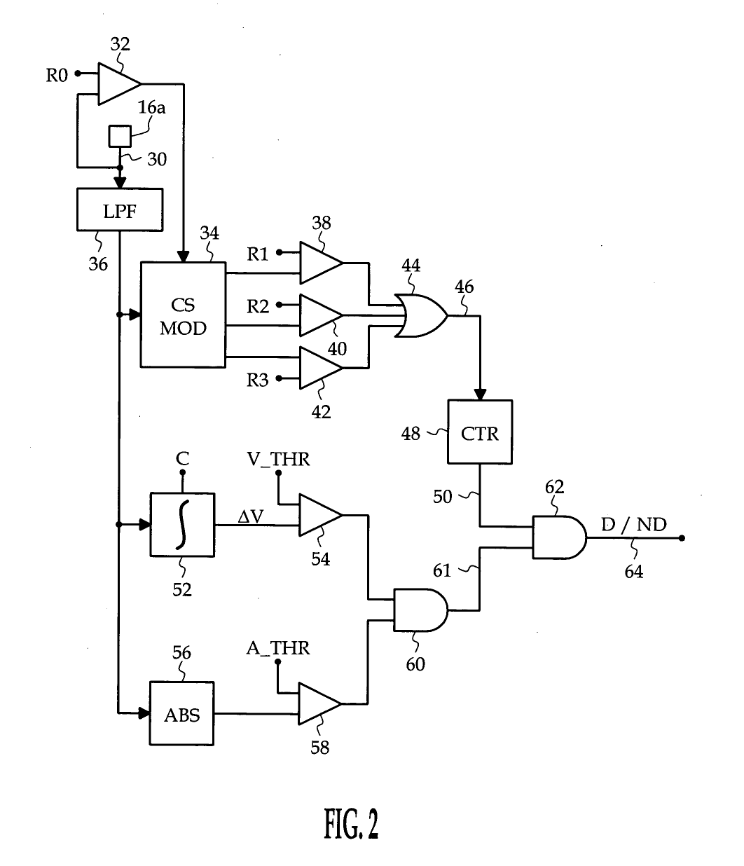

The principle functions performed by SDM 14 include monitoring the acceleration signals to detect the onset of a crash event, and thereafter assessing the crash severity and issuing a deployment command for some or all of the restraints 12a-12h if both crash severity and immunity conditions are concurrently satisfied. The block diagram of FIG. 2 illustrates this functionality in respect to the side impact acceleration sensor 16a. The sensor 16a will typically include discrete low pass filter elements to limit the frequency content of the acceleration signal output on line 30, although such signal is commonly referred to as the raw acceleration. The comparator 32 is responsive to the acceleration signal on line 30, and activates a crash severity model 34 when the acceleration signal exceeds a reference value R0, indicating the onset of a potential crash event. The primary input to the crash severity model 34 is a filtered version of the raw acceleration signal. The filtering is provided low-pass filter (LPF) 36, which passes acceleration signal frequencies in the range of approximately 80-150 Hz. The crash severity model 34 typically produces several potential crash severity indices, which are compared to respective reference values R1, R2, R3 by the comparators 38, 40, 42. The comparator outputs are subjected to a logical-OR function 44 so that an output is produced on line 46 whenever at least one of the crash severity indices exceeds the respective threshold. The output of OR-gate 44 on line 46 is supplied to a counter (CTR) 48 or similar timing function, which produces an output on line 50 for 30-50 milliseconds after OR-gate 44 produces an output on line 46.

The blocks 52-62 of FIG. 2 provide immunity from deployment due to non-deployment events by requiring concurrent satisfaction of both the above-described crash severity conditions and two immunity conditions. The first immunity condition is defined by the blocks 52 and 54, which respectively determine the change in velocity associated with the filtered acceleration output of low-pass filter 36, and compare the change in velocity to a velocity threshold V_THR such as 8-10 MPH. The block 52 periodically samples the filtered acceleration signal, and computes the change in velocity V(I) as follows:,
V(I)=V(I−1)+A(I)−C
where V(I−1) is the previous value of the velocity V(I), A(I) is the current sample of the filtered acceleration and C is a decay constant that compensates for sensor drift. Comparing the velocity V(I) to the threshold V_THR ensures that an actual crash event is in progress and verifies the direction of the crash energy. The second immunity condition is defined by the blocks 56 and 58, which respectively determine the absolute value of the filtered acceleration (that is, |A(I|), and compare |A(I)| to an acceleration threshold A_THR such as 50-80 g. The functionality of blocks 56 and 58 can alternatively be achieved by using two comparator blocks to compare A(I) to both positive and negative acceleration thresholds, and combining the comparator outputs with a logical-OR function. Either approach utilizes both positive and negative excursions of the filtered acceleration signal, and establishes an immunity condition requiring that the absolute magnitude of the filtered acceleration exceed the threshold A_THR. The block 60 performs a logical-AND function to produce an output on line 61 when the first and second immunity conditions are concurrently satisfied, and the block 62 performs a logical-AND function to produce a deploy output on deploy/no-deploy (D/ND) line 64 when outputs are present on both lines 60 and 61. Compared with the method described in the aforementioned U.S. Pat. No. 5,483,449 to Caruso et al., the immunity method of this invention utilizes the entire information content of the filtered acceleration signal, and prevents delays in restraint deployment due to negative excursions of the filtered acceleration signal.

In summary, the present invention provides an effective and easily implemented method of providing deployment immunity against non-crash events and non-deployment crash events, while avoiding delay of restraint deployment in severe crash events. While the method of the present invention has been described with respect to the illustrated embodiment, it is recognized that numerous modifications and variations in addition to those mentioned herein will occur to those skilled in the art. For example, the method may be applied to frontal and other restraints as well as side restraints, and to systems having fewer or more crash sensors than illustrated. Also, crash severity may be judged by factors instead of or in addition to those described, and so on. Accordingly, it is intended that the invention not be limited to the disclosed embodiment, but that it have the full scope permitted by the language of the following claims.

1. A method of deploying a vehicle supplemental restraint based on a measure of vehicle acceleration and a crash severity indication, the method comprising the steps of:
periodically sampling the measure of vehicle acceleration and determining a corresponding change in velocity;
low-pass filtering the measured acceleration;
determining an absolute magnitude of the filtered acceleration;
determining that an immunity condition is satisfied so long as the change in velocity exceeds a specified velocity threshold and the determined absolute magnitude of the filtered acceleration exceeds a specified acceleration threshold; and
allowing deployment of said supplemental restraint based on said crash severity indication only when it is determined that said immunity condition is satisfied.

2. The method of claim 1, including the step of:
allowing deployment of said supplemental if said immunity condition is satisfied with a predetermined period of time after said crash severity indication exceeds a severity threshold.

3. The method of claim 1, including the steps of:
determining an absolute value of said filtered acceleration;
comparing said absolute value to an acceleration threshold; and
determining that said immunity condition is satisfied so long as the change in velocity exceeds a specified velocity threshold and said absolute value exceeds said acceleration threshold.
